(19) United States
(12) Patent Application Publication
(10) Pub. No.: US 2013/0222569 A1
(43) Pub. Date: Aug. 29, 2013

(54) IMAGING APPARATUS

(71) Applicants: Tomoaki Kawakami, Utsunomiya-shi (JP); Toshihiko Tsuji, Utsunomiya-shi (JP)

(72) Inventors: Tomoaki Kawakami, Utsunomiya-shi (JP); Toshihiko Tsuji, Utsunomiya-shi (JP)

(21) Appl. No.: 13/881,302

(22) PCT Filed: Oct. 17, 2011
(86) PCT No.: PCT/JP2011/074372

§ 371 Date: Apr. 24, 2013

(30) Foreign Application Priority Data
Oct. 27, 2010 (JP) 2010-241208

(51) Int. Cl. H04N 5/225

(52) U.S. Cl. CPC H04N 5/2256
USPC 348/79

(57) ABSTRACT

An imaging apparatus includes: an illumination optical system including a light source and guiding the light from the light source to an illuminated surface B including an object; a plurality of image sensors for acquiring an image of the illuminated surface formed by an imaging optical system; a measurement unit for measuring a size of the object; and a control unit for determining an image sensor to be used when acquiring the image of the illuminated surface, among the plurality of image sensors, based on a measurement result of the measurement unit.

### TECHNICAL FIELD

The present invention relates to a constitution of an imaging apparatus acquiring an image of an object.

### BACKGROUND ART

In recent years, attention has been directed to an imaging apparatus which can convert information on cellular tissues obtained from a whole specimen into an image and display the image on a monitor.

Japanese Patent Application Laid-Open Nos. 2009-003016 and 2009-063665 discuss a method for capturing an image at a high speed and high magnification using an object lens having a large visual field and high resolution and providing a plurality of image sensors. These methods capture images by driving the specimen or the image sensors a plurality of times, synthesize the captured images to form a whole image, and acquire information on cellular tissues from a whole specimen as an image. The plurality of image sensors are used herein since it is difficult to prepare a large image sensor capable of collectively capturing an image in a very wide visual field.

When the image of the whole specimen is formed by an optical system having a wide field of view and high resolution as described in Japanese Patent Application Laid-Open Nos. 2009-063665 and 2008-107403, an object which should be imaged may become smaller than a field of view. Since a portion unnecessary for imaging is also illuminated and imaged in this case, useless electric power may be consumed.

An example of illumination when the object becomes smaller than the field of view is shown in FIG. 2. FIG. 2A shows a view in which an object (specimen 225) is illuminated. A sample retention part 220 (for example, a slide glass) retains a specimen 225. Reference number 227 denotes an illuminated region. FIG. 2B shows a condition in an imaging surface of an imaging apparatus. Namely, FIG. 2B shows an image 225C of the specimen 225, an electric substrate 420, an image sensor 430, and a region 227C where the image of the illumination region 227 is formed on the imaging surface.

As described above, the whole surface of the imageable region is illuminated in order to photograph the image of the object smaller than the field of view. Since light forming the image on a portion other than the image sensor does not play a role in imaging, such light leads to increase of electric power consumption. In addition, when the light is reflected as scattering light in the apparatus and is incident on the image sensor, the light causes degradation of image quality.

Consequently, a method for illuminating an object according to the size thereof is discussed in, for example, Japanese Patent Application Laid-Open No. 2008-107403. In a scanning microscope of Japanese Patent Application Laid-Open No. 2008-107403, a light-shielding object which optionally regulates an illumination range is disposed in the vicinity of the object, and a portion to be imaged is illuminated.

However, since an amount of emission to be used from a light source is not itself changed even when the illumination range is controlled by the light-shielding object, the electric power consumption cannot be reduced. When many portions having no relation with image data are imaged, image processing requires time, and an amount of image data is unnecessarily enlarged.

The enlargement of the image data requires excessive infrastructure construction for transmitting and receiving the enlarged image data when an image acquired in a remote place is read from another remote place. This causes increase of user's cost.

### SUMMARY OF INVENTION

According to an aspect of the present invention, an imaging apparatus includes an illumination optical system including a light source and guiding the light from the light source to an illuminated surface including an object, a plurality of image sensors for acquiring an image of the illuminated surface formed by an imaging optical system, a measurement unit for measuring a size of the object, and a control unit for determining an image sensor to be used when acquiring the image of the illuminated surface, among the plurality of image sensors, based on a measurement result of the measurement unit.

According to another aspect of the present invention, an imaging apparatus includes an illumination optical system including a plurality of light sources and discretely guiding the light from the plurality of light sources to an illuminated surface including an object, a plurality of image sensors for acquiring an image of the illuminated surface formed by an imaging optical system, a measurement unit for measuring a size of the object, and a control unit for determining a light source to be used when acquiring the image of the illuminated surface, among the plurality of light sources, based on a measurement result of the measurement unit.

According to yet another aspect of the present invention, an imaging apparatus includes an illumination optical system including a plurality of light sources and discretely guiding the light from the plurality of light sources to an illuminated surface including an object, an image sensor for acquiring an image of the illuminated surface formed by an imaging optical system, a measurement unit for measuring a size of the object, and a control unit for determining not to use a light source which does not illuminate the object, among the plurality of light sources when acquiring an image of the illuminated surface, based on a measurement result of the measurement unit.

Further features and aspects of the present invention will become apparent from the following detailed description of exemplary embodiments with reference to the attached drawings.

### BRIEF DESCRIPTION OF DRAWINGS

The accompanying drawings, which are incorporated in and constitute a part of the specification, illustrate exemplary embodiments, features, and aspects of the invention and, together with the description, serve to explain the principles of the invention.

FIG. 1 is an entire view of an imaging apparatus of the present invention.

FIG. 2A illustrates an illumination state when an optically-axisymmetric region is illuminated.

FIG. 2B illustrates an illumination state when an optically-axisymmetric region is illuminated.

FIG. 3A illustrates a light source unit and an optical rod.

FIG. 3B illustrates a light source unit and an optical rod.

FIG. 4A shows an illumination state of an emission surface of the optical rod.

FIG. 4B shows an illumination state of an emission surface of the optical rod.

FIG. 4C shows an illumination state of an emission surface of the optical rod.

FIG. 5A shows an illumination state and an imaging state when imaging a large specimen.

FIG. 5B shows an illumination state and an imaging state when imaging a large specimen.

FIG. 5C shows an illumination state and an imaging state when imaging a large specimen.

FIG. 6A shows an illumination state and an imaging state when imaging a small specimen.

FIG. 6B shows an illumination state and an imaging state when imaging a small specimen.

FIG. 6C shows an illumination state and an imaging state when imaging a small specimen.

FIG. 7A shows an illumination state and an imaging state when capturing the entire image of the large specimen.

FIG. 7B shows an illumination state and an imaging state when capturing the entire image of the large specimen.

FIG. 7C shows an illumination state and an imaging state when capturing the entire image of the large specimen.

FIG. 7D shows an illumination state and an imaging state when capturing the entire image of the large specimen.

FIG. 7E shows an illumination state and an imaging state when capturing the entire image of the large specimen.

FIG. 7F shows an illumination state and an imaging state when capturing the entire image of the large specimen.

FIG. 7G shows an illumination state and an imaging state when capturing the entire image of the large specimen.

FIG. 7H shows an illumination state and an imaging state when capturing the entire image of the large specimen.

FIG. 8A shows an illumination state and an imaging state when capturing the entire image of the small specimen.

FIG. 8B shows an illumination state and an imaging state when capturing the entire image of the small specimen.

FIG. 8C shows an illumination state and an imaging state when capturing the entire image of the small specimen.

FIG. 8D shows an illumination state and an imaging state when capturing the entire image of the small specimen.

FIG. 8E shows an illumination state and an imaging state when capturing the entire image of the small specimen.

FIG. 8F shows an illumination state and an imaging state when capturing the entire image of the small specimen.

FIG. 8G shows an illumination state and an imaging state when capturing the entire image of the small specimen.

FIG. 8H shows an illumination state and an imaging state when capturing the entire image of the small specimen.

FIG. 9A shows an illumination state and an imaging state when capturing the entire image of the small specimen.

FIG. 9B shows an illumination state and an imaging state when capturing the entire image of the small specimen.

FIG. 9C shows an illumination state and an imaging state when capturing the entire image of the small specimen.

FIG. 9D shows an illumination state and an imaging state when capturing the entire image of the small specimen.

FIG. 9E shows an illumination state and an imaging state when capturing the entire image of the small specimen.

FIG. 9F shows an illumination state and an imaging state when capturing the entire image of the small specimen.

FIG. 9G shows an illumination state and an imaging state when capturing the entire image of the small specimen.

FIG. 9H shows an illumination state and an imaging state when capturing the entire image of the small specimen.

FIG. 10A shows an illumination state and an imaging state when capturing the entire image of the small specimen.

FIG. 10B shows an illumination state and an imaging state when capturing the entire image of the small specimen.

FIG. 10C shows an illumination state and an imaging state when capturing the entire image of the small specimen.

FIG. 10D shows an illumination state and an imaging state when capturing the entire image of the small specimen.

FIG. 10E shows an illumination state and an imaging state when capturing the entire image of the small specimen.

FIG. 10F shows an illumination state and an imaging state when capturing the entire image of the small specimen.

FIG. 10G shows an illumination state and an imaging state when capturing the entire image of the small specimen.

FIG. 10H shows an illumination state and an imaging state when capturing the entire image of the small specimen.

FIG. 11A illustrates a case where an illumination region is changed by one rod.

FIG. 11B illustrates a case where an illumination region is changed by one rod.

FIG. 12 illustrates a case where a lens array is used as an optical integrator.

FIG. 13 illustrates a case where a lens array is used as an optical integrator.

FIG. 14A illustrates a case where a lens array is used as an optical integrator.

FIG. 14B illustrates a case where a lens array is used as an optical integrator.

### DESCRIPTION OF EMBODIMENTS

Various exemplary embodiments, features, and aspects of the invention will be described in detail below with reference to the drawings.

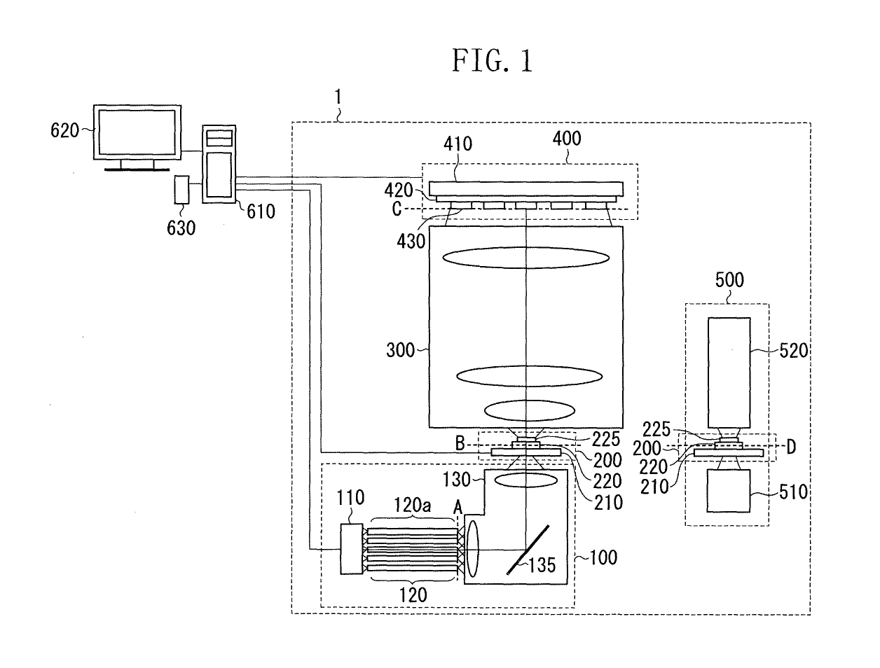

FIG. 1 is a schematic view of an imaging apparatus using a transmission electron microscope of a first exemplary embodiment of the present invention. In FIG. 1, an imaging apparatus 1 has an illumination optical system 100 for guiding the light from a light source unit 110 to an irradiated surface B, and a sample part 200. Furthermore, the imaging apparatus 1 has an imaging optical system 300 for forming an image of an object on the irradiated surface B, an imaging unit 400 having image sensors 430 such as a plurality of charge-coupled devices (CCDs) and complementary metal-oxide semiconductors (CMOSs) disposed on an imaging surface (image surface) C of the imaging optical system 300, and a measurement optical system 500 for measuring the size and position of the object. The measurement optical system 500 includes a measurement illumination optical system 510 and a measurement imaging optical system 520. Herein, a system including the illumination optical system 100, the imaging optical system 300, and the plurality of image sensors 430 is defined as an imaging unit, and a system including the measurement optical system 500 is defined as a measurement unit.

First, the measurement optical system 500 measures the size and position of the object. The object, which is a specimen 225, is retained by a sample retention part 220 including, for example, a slide glass and a cover glass (not shown). The sample part 200 includes a sample stage 210 and the sample retention part 220. The sample stage 210 can drive the sample retention part 220 so that the position of the sample retention part 220 is set in an optical axis direction or a direction perpendicular to an optical axis, or is inclined toward the optical axis. When the specimen 225 is retained so that the specimen 225 coincides with an irradiated surface D, the specimen 225 illuminated by the measurement illumination optical system 510 is imaged by the measurement imaging optical system 520, to measure the size thereof. For example, the size and the position are measured using information obtained from an image sensor such as a CCD or a CMOS included in the measurement imaging optical system 520.

The measurement illumination optical system 510, which radiates a luminous flux for illuminating the specimen 225, includes, for example, one or more halogen lamps, xenon lamps, laser diodes (LDs), and light-emitting diodes (LEDs). The measurement imaging optical system 520 captures an image of the specimen 225 on the illuminated surface D, and measures the position and size thereof. Since the measurement imaging optical system 520 is an optical system for recognizing the size and the position, the measurement imaging optical system 520 may be an optical system having resolution lower than that of the imaging optical system 300.

After the size of the specimen 225 is measured by the measurement optical system 500 as described above, the sample stage 210 is then driven so that the specimen 225 coincides with the surface B. The specimen 225 is imaged using the illumination optical system 100, the imaging optical system 300, and the imaging unit 400. However, although an example of measuring the size of the specimen using light is shown herein, the constitution of the example is not particularly limited as long as the example can measure the size of the specimen.

The illumination optical system 100 includes the light source unit 110, an optical rod 120 having a plurality of optical rods (rod integrators) 120a, and a conjugate optical system 130. The light source unit 110, which radiates a luminous flux for illuminating the specimen 225, includes, for example, one or more halogen lamps, xenon lamps, and LEDs.

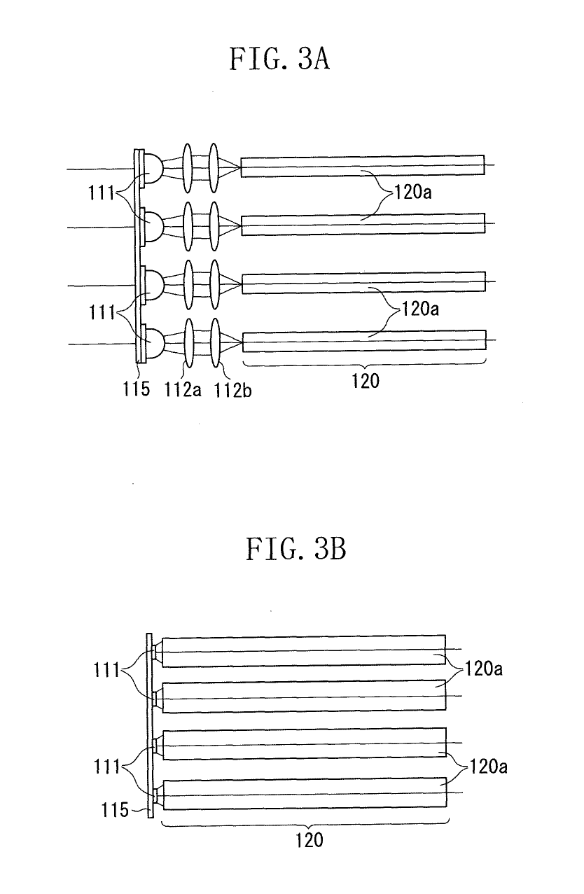

The light source unit 110 supplies light to only the plurality of optical rods 120a. For example, as shown in FIG. 3A, divergent lights from a plurality of light sources 111 disposed on an electric substrate 115 are parallelized by a lens array 112a. The parallelized lights are condensed at a desired position and angle by a lens array 112b. The condensed light is independently supplied to each of the optical rods 112a. Alternatively, as shown in FIG. 3B, the light from each of the plurality of light sources 111 disposed on the electric substrate 115 is incident on each of the optical rods 112a located on the post-stage of each of the light sources 111.

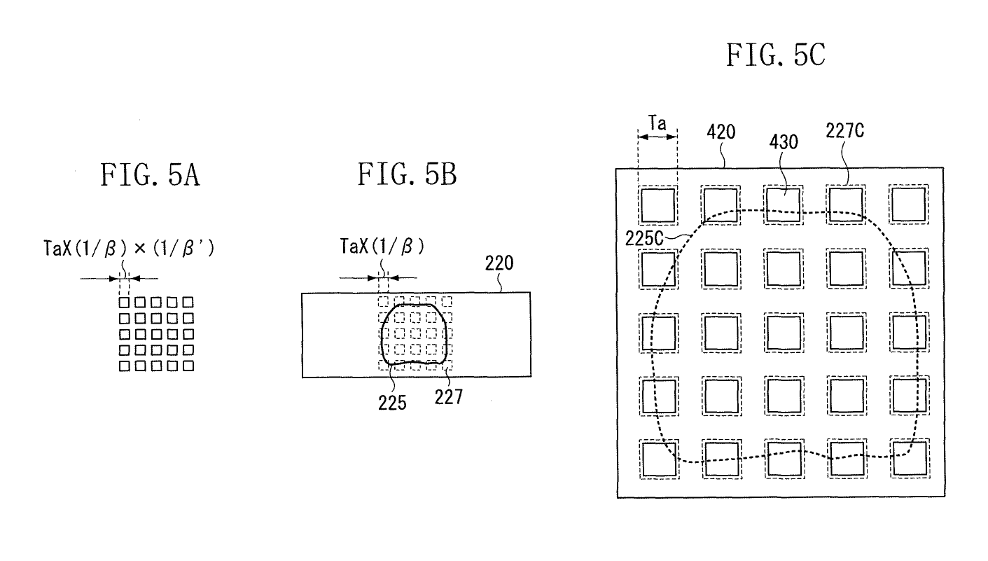

The optical rod 120 internally and totally reflects the luminous flux radiated from the light source unit 110, to guide the luminous flux without leaking the luminous flux to the side surface, thereby forming a uniform illuminating surface on an emission end surface of each of the optical rods 120a. When the emission surface of the optical rod 120 is defined as an emission surface A, the emission surface A, corresponding to the plurality of optical rods 120a, as shown in FIG. 5A, discretely forms a uniform illumination distribution. When ON/OFF of the light source supplying light to each of the optical rods 120a is switched over, a variety of forms of illumination can be formed on the emission surface of the rod. Herein, the emission surface A of the optical rod is configured to have a conjugate relationship with an imaging surface C of the imaging optical system 300. However, the emission surface A is not necessarily disposed at a position completely conjugational to the imaging surface C. The emission surface A may be disposed at a position substantially conjugational to the imaging surface C.

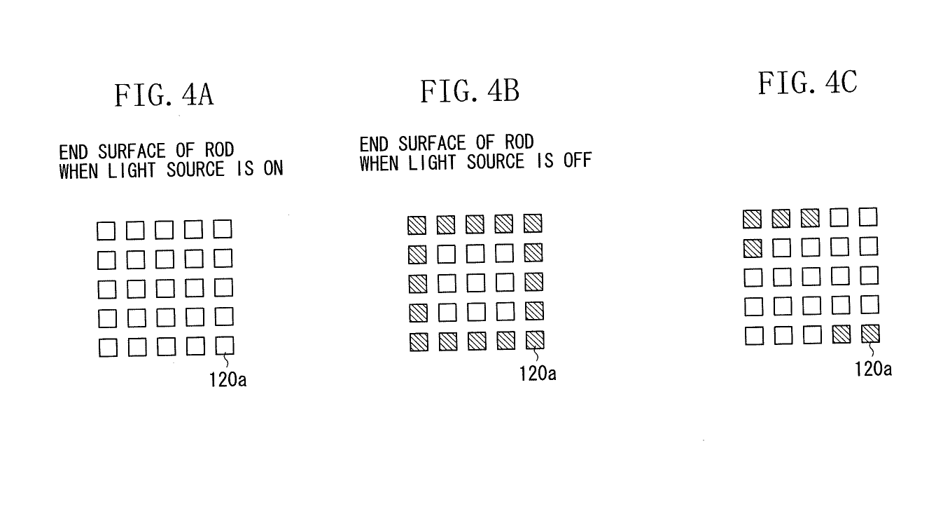

An example will be shown in FIG. 4. When all the light sources are brought into an ON state, an illumination distribution shown in FIG. 4A can be formed. When some light sources are brought into an OFF state, illumination distributions as shown in FIGS. 4B and 4C can be formed. The end surface of the rod when the light source is brought into an ON state is represented in white, and the end surface of the rod when the light source is brought into an OFF state is represented by oblique lines.

The image of the surface is formed by the conjugate optical system 130, and the surface B is illuminated with the image. As long as uniformity required for imaging is obtained on the illuminated surface B in the conjugate optical system 130, the illuminated surface B is not necessarily disposed at a position completely conjugational to the emission surface A. The illuminated surface B may be disposed at a position substantially conjugational to the emission surface A.

Since the constitution of the illumination optical system 100 enables the variety of illuminating forms as described above, the illumination distribution can be appropriately controlled depending on the size of the specimen 225. When the specimen 225 is large, illumination regions 227 in the illuminated surface B are uniformly and discretely illuminated by supplying lights to all the optical rods as shown in FIG. 5B. Dotted lines of FIG. 5B represent illuminated regions.

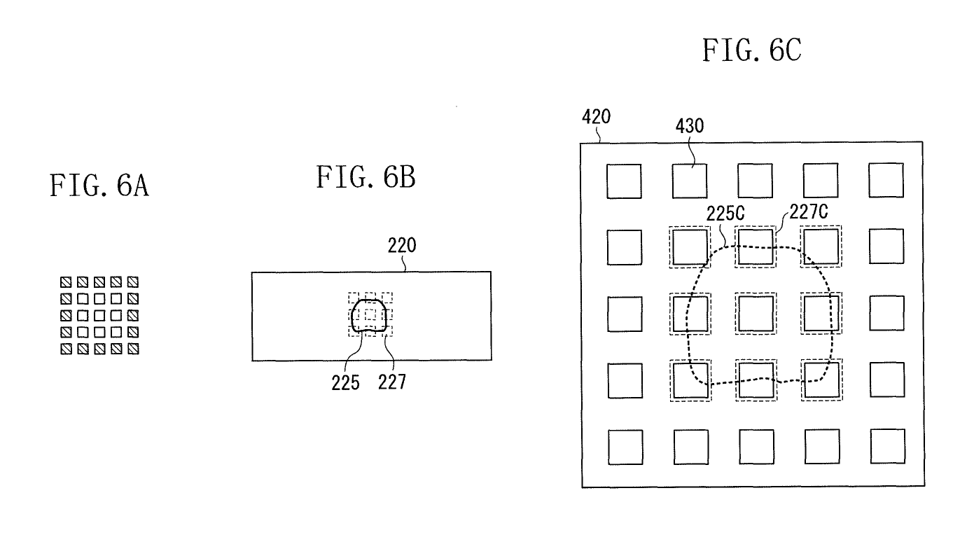

On the other hand, when the specimen 225 is small, only the light sources to be used are brought into an ON state so that only regions required for imaging are illuminated. At this time, the illumination distribution of the emission surface A is formed as shown in FIG. 6A, and the illumination distribution of the illuminated surface B is formed as shown in FIG. 6B. This can reduce electric power consumption without illuminating unnecessary portions since some lights are brought into an OFF state.

The imaging optical system 300 is an optical system which forms the image of the specimen 225 illuminated on the illuminated surface B, on the imaging surface C at a wide viewing angle and high resolution. As shown by a dotted line of FIG. 5C, the image of the specimen 225 is formed as an image 225C on the imaging surface C by the imaging optical system 300. As shown in the Figures, the lights from the light sources are guided to the image sensors 430 on a one-on-one basis.

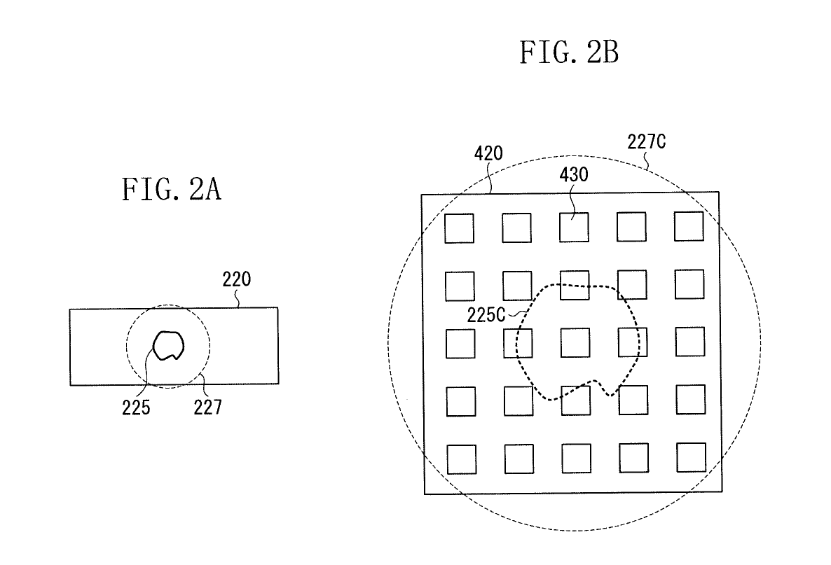

The imaging unit 400 includes an imaging stage 410, an electric substrate 420, and a plurality of image sensors 430. As shown in FIGS. 2B and 5C, the image sensors 430 are disposed with a space on the electric substrate 420. The image sensors 430 are disposed to coincide with the imaging surface C of the imaging optical system 300 on the imaging stage 410. The size 227C of the image of each of the illumination regions in which the specimen 225 is illuminated coincides with the size of the image sensor 430 on the imaging surface C. Although the size 227C does not necessarily coincide with the size 430 completely, light can be efficiently utilized as the size 227C is closer to the size 430. Since the light with which a region other than the image sensor is irradiated is reduced, effects of scattering light which degrades image quality can be reduced.

When the optical magnification of the imaging optical system is defined as β; the optical magnification of the conjugate optical system is defined as β′; and the size of the image sensor 430 is □T, the size of the end surface of the rod is □T×(1/β)×(1/β′). Each of the image sensors may have a slight margin so that the image of the specimen is formed on only a region of □T×a (mm) (a>1). In that case, the size of the end surface of the rod is □T×a×(1/β)×(1/β′) as shown in FIG. 5A. Alternatively, when the shape of the image sensor is a rectangle, the shape of the end surface of the rod is made a rectangle similar to that of the image sensor. Herein, the rectangle is described as an example. However, the shape is not limited to the rectangle, and the image sensor and the end surface of the rod may have a shape corresponding to each other. The corresponding shape means that the shape of the emission surface of the optical rod is also made a rectangle or a hexagon when the shape of the image sensor is the rectangle or the hexagon. When the image sensor and the emission surface of the optical rod have a similar shape or a substantially similar shape, the light receiving area of the image sensor can be more effectively utilized.

When the optical magnification of the imaging optical system is defined as β; the optical magnification of the conjugate optical system is defined as β′; and the sizes of the image sensor 430 in an X direction and a Y direction are respectively defined as Tx and Ty, the length of the end surface of the rod in the X direction is Tx×(1/β)×(1/β′) and the length of the end surface of the rod in the Y direction is Ty×(1/β)×(1/β′). At this time, when the specimen 225 measured by the measurement optical system 500 is large, all the image sensors corresponding to the illumination region 227C on the imaging surface C are used in FIG. 5C. When the specimen 225 measured by the measurement optical system 500 is small, only some light sources required for imaging are brought into an ON state. Only some image sensors corresponding to the illumination region 227C on the imaging surface C are used in FIG. 6C (in other words, the image sensor on which the image of the object is not formed is not used). When the image is captured by only the image sensors on which the image of the specimen 225 is formed, other image sensors do not capture the image, which can reduce electric power consumption. Since one end surface of the rod corresponds to one image sensor in this case, the image sensor to be used can be also uniquely determined when the light source to be used is determined.

In the imaging apparatus of the present invention, the position of at least one of the emission surface A, the illuminated surface B, and the imaging surface C is relatively changed in a plane orthogonal to the optical axis, and the object on the illuminated surface B is imaged a plurality of times. When the specimen 225 has a size equivalent to that of the viewing angle or equal to or greater than that of the viewing angle as shown in FIG. 5, all of the plurality of light sources 111 and all of the plurality of image sensors 430 are used. A method for acquiring the image of the whole specimen at this time is shown below.

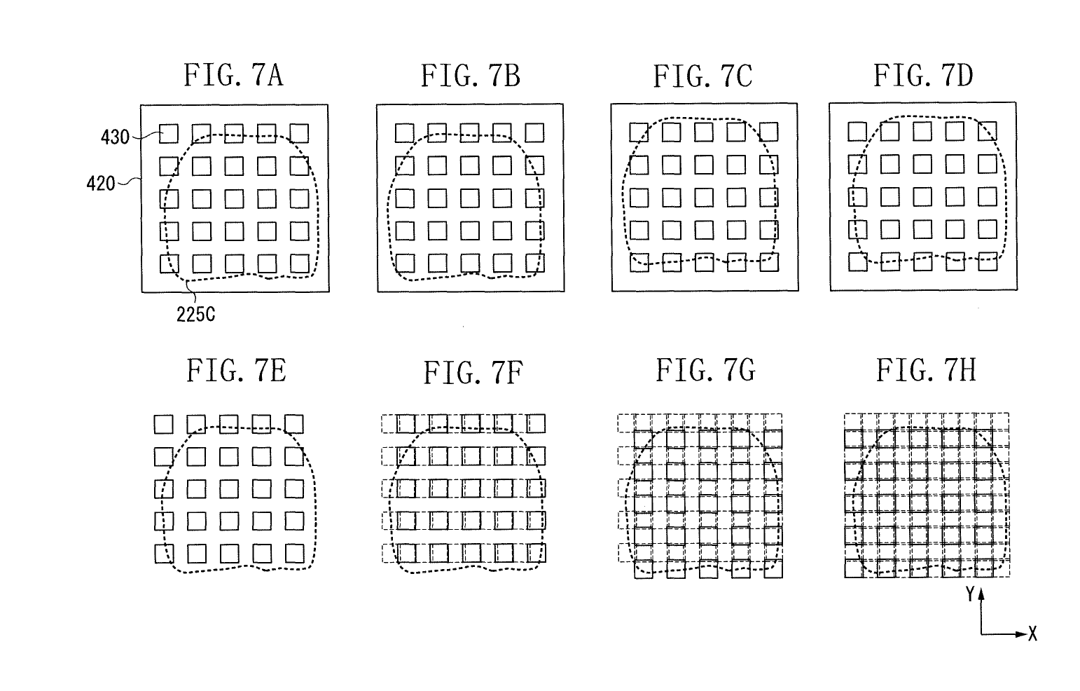

FIG. 7 shows the relationship between the image sensor 430 and the image 225C of the specimen 225 in the imaging unit 400 when the specimen 225 is deviated by an effective dimension of the image sensor 430 in a direction (XY direction) perpendicular to the optical axis. In the example of FIG. 7, the relationship between the image sensor and the image of the specimen to be used is shown in FIG. 7A for the first imaging, in FIG. 7B for the second imaging, in FIG. 7C for the third imaging, and in FIG. 7D for the fourth imaging. FIGS. 7E to 7H show the images captured up to the time of imaging in FIGS. 7A to 7D respectively. In FIGS. 7E to 7H, portions imaged immediately before are surrounded by solid lines, and portions previously imaged are shown by dotted lines.

When an image is captured for the first time at the position of FIG. 7A, the image 225C of the specimen 225 is discretely captured only in the regions where the image sensors exist as shown in FIG. 7E.

Next, the specimen 225 is deviated, and an image is captured for the second time at the position of FIG. 7B. In that case, when the image is combined with the image previously acquired, portions shown in FIG. 7F are imaged.

The specimen 225 is further deviated, and an image is captured for the third time at the position of FIG. 7C. In that case, FIG. 7G is imaged. When an image is finally captured for the fourth time in FIG. 7D, portions shown in FIG. 7H are imaged as a whole.

The plurality of images thus captured can be synthesized by an image processing unit included in a control unit 610, to form the image of the whole imaging region. On the other hand, in the case of FIG. 6 in which the specimen 225 is smaller than the viewing angle, the image of the whole specimen 225 is acquired using only some light sources 111 and image sensors 430.

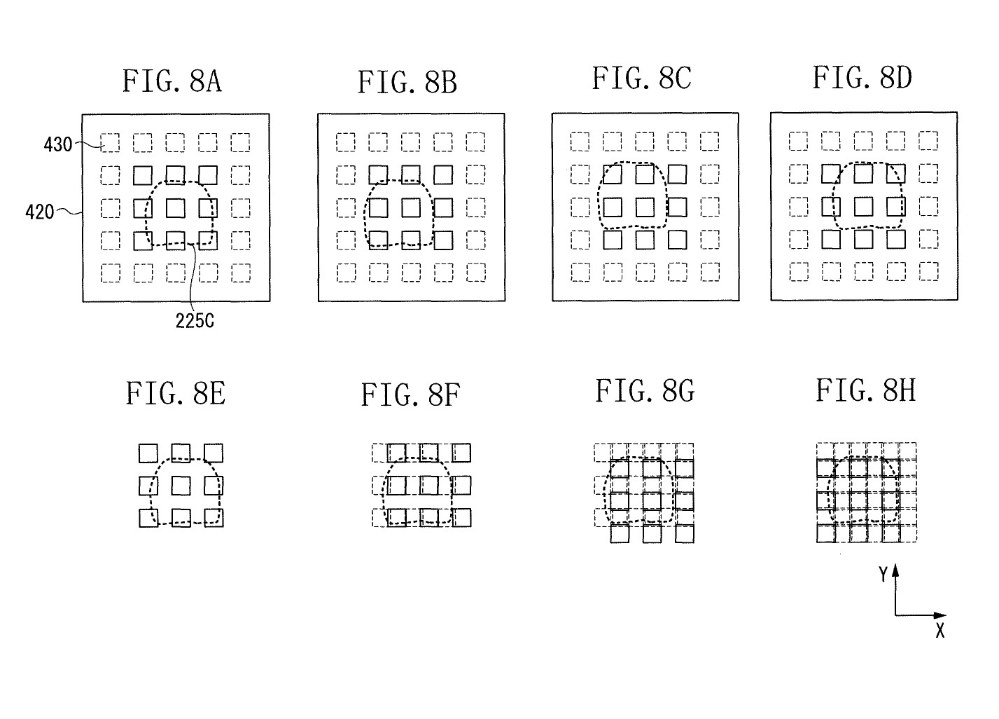

FIG. 8 shows the relationship between the image sensor 430 and the image 225C of the specimen 225 in the imaging unit 400 when the specimen 225 is deviated by the effective dimension of the image sensor 430 in the direction (XY direction) perpendicular to the optical axis as in FIG. 7. In FIGS. 8A to 8D, the used image sensors 430 are shown by solid lines, and the unused image sensors 430 are shown by dotted lines. In this exemplary embodiment, only the light sources corresponding to the used image sensors 430 are brought into an ON state. In FIGS. 8E to 8H, portions imaged immediately before are surrounded by solid lines, and portions previously imaged are shown by dotted lines.

FIG. 8A shows the imaging for the first time. As shown in FIG. 8E, the image 225C of the specimen 225 is discretely captured only in regions where the image sensors exist, by using nine light sources to illuminate only nine middle illumination regions, and using only nine middle image sensors 430.

Next, the sample retention part 220 is deviated, and an image is captured for the second time at the position of FIG. 8B. In that case, when the image is combined with the image previously acquired, a portion shown in FIG. 8F is imaged.

The specimen 225 is further deviated, and an image is captured for the third time at the position of FIG. 8C. In that case, FIG. 8G is imaged. When an image is finally captured for the fourth time in FIG. 8D, portions shown in FIG. 8H are imaged.

Thus, a plurality of image data are synthesized by the control unit 610 including the image processing unit in FIG. 1. The image is stored in a recording unit 630 such as a memory, and is displayed on an image display unit 620 such as a monitor. The control unit 610 has functions to determine the light sources and image sensors to be used, and to drive and control the sample stage 210, in addition to image processing. Although these functions were performed by one control unit 610 herein, different control units may be respectively prepared for the functions, to play respective roles.

As described above, the light sources and image sensors to be used are determined according to the size of the specimen. Accordingly, in a case where the specimen is small, the image of the whole specimen can be formed with a small amount of data with low electric power consumption by using only some light sources and image sensors. Furthermore, since the light with which the region other than the image sensors is irradiated is reduced, the effects of the scattering light which causes degradation of image quality can be reduced.

The electric power consumption can also be reduced by controlling the light sources to be used according to the size of the specimen even when a large-sized image sensor is used without using the plurality of image sensors.

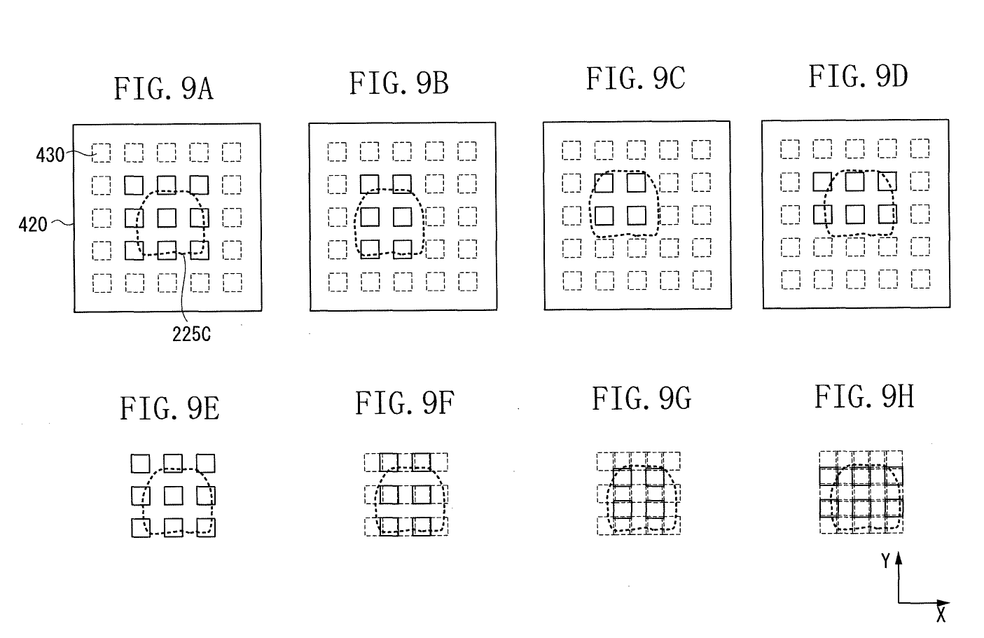

Hereinafter, a second exemplary embodiment will be described. When the whole image of one specimen is acquired by imaging four times in the first exemplary embodiment, the same light sources and image sensors are used for the first to the fourth time. However, the light sources and image sensors used at each of the imaging times can be changed and an example thereof is shown in FIG. 9. In the example of FIG. 9, the relationship between the image sensor and the image of the specimen to be used is shown in FIG. 9A for the first imaging, in FIG. 9B for the second imaging, in FIG. 9C for the third imaging, and in FIG. 9D for the fourth imaging. In FIGS. 9A to 9D, the used image sensors 430 are shown by solid lines, and the unused image sensors 430 are shown by dotted lines. In this exemplary embodiment, only the light sources corresponding to the used image sensors 430 are brought into an ON state.

Image data obtained in the first imaging is shown in FIG. 9E; image data obtained in the second imaging is shown in FIG. 9F; image data obtained in the third imaging is shown in FIG. 9G; and image data obtained in the fourth imaging is shown in FIG. 9H. In FIGS. 9E to 9H, portions imaged immediately before are surrounded by solid lines, and portions previously imaged are shown by dotted lines.

In FIG. 8, nine image sensors are always used for the first to fourth imagings. However, as shown in FIG. 9, in this exemplary embodiment, the number of the image sensors used at the time of each imaging is changed, to further reduce the number of the image sensors to be used as a whole. Therefore, although the specimen having the same size is imaged in FIGS. 8 and 9, the finally obtained image in FIG. 9H is smaller than that in FIG. 8H.

The light sources and image sensors to be used at each imaging are changed as shown in FIGS. 9A to 9D without using the same light sources and image sensors. Thereby, finally, as shown in FIG. 9H, unnecessary data is suppressed, and the image of the whole specimen can be acquired.

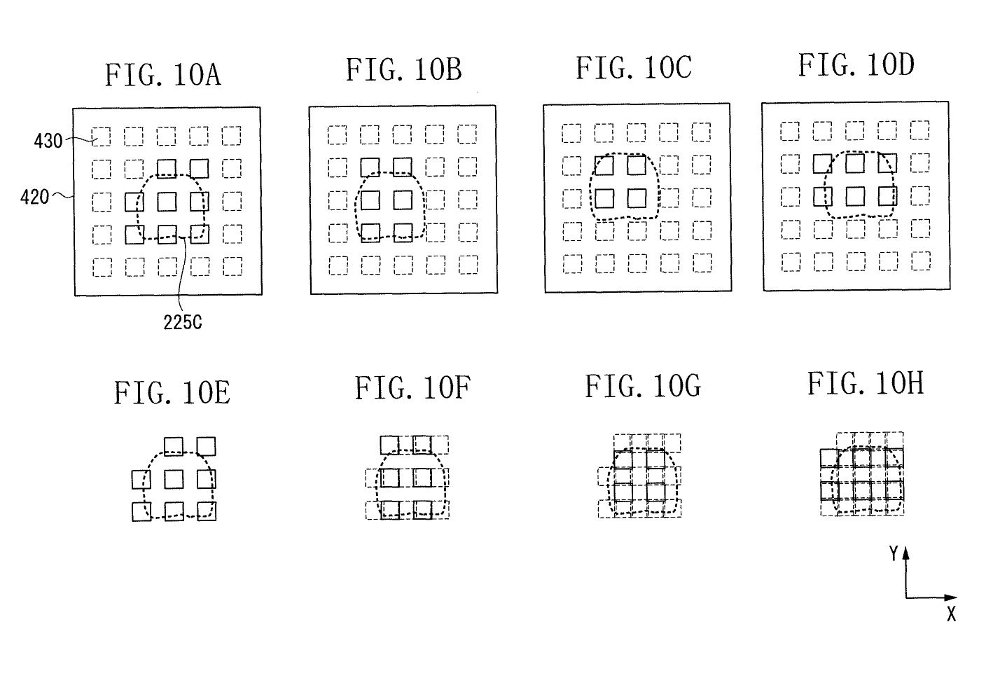

Hereinafter, a third exemplary embodiment will be described. Typically, the image often has a rectangle shape. However, when a specimen does not have a rectangle shape or a shape close to the rectangle, the image to be captured can be also of a shape other than the rectangle. Thereby, the light sources and the image sensors to be used can be reduced, and a load of the processing can be alleviated. In the example of FIG. 10, the relationship between the image sensor and the image of the specimen to be used is shown in FIG. 10A for the first imaging, in FIG. 10B for the second imaging, in FIG. 10C for the third imaging, and in FIG. 10D for the fourth imaging. In FIGS. 10A to 10D, the used image sensors 430 are shown by solid lines, and the unused image sensors 430 are shown by dotted lines. In this exemplary embodiment, only the light sources corresponding to the used image sensors 430 are brought into an ON state.

Image data obtained in the first imaging is shown in FIG. 10E; image data obtained in the second imaging is shown in FIG. 10F; image data obtained in the third imaging is shown in FIG. 10G; and image data obtained in the fourth imaging is shown in FIG. 10H. In FIGS. 10E to 10H, portions imaged immediately before are surrounded by solid lines, and portions previously imaged are shown by dotted lines.

As shown in FIG. 10, the number of the light sources and image sensors to be used in the first imaging is less than that in FIG. 9.

Since the image of the specimen is absent in a left corner, the image of FIG. 10H is synthesized without imaging the first left corner. However, since the image data typically has a rectangle shape, the image data is generated dealing with the left corner part as an unprocessed blank image when pasting the images.

The light sources and image sensors to be used are further reduced by this method, and the pasted parts are reduced, so that a load of the processing can be further alleviated.

Hereinafter, a fourth exemplary embodiment will be described. Since the end surface of one optical rod corresponds to one image sensor in the first to third exemplary embodiments, the image sensors to be used can be also uniquely determined when the light sources to be used are determined.

However, due to restriction on design such as the optical system magnification β of the imaging optical system, the optical system magnification β′, of the conjugate optical system, and the imaging region, it may be difficult to make one optical rod correspond to one image sensor. In that case, one optical rod may be made to correspond to a plurality of image sensors.

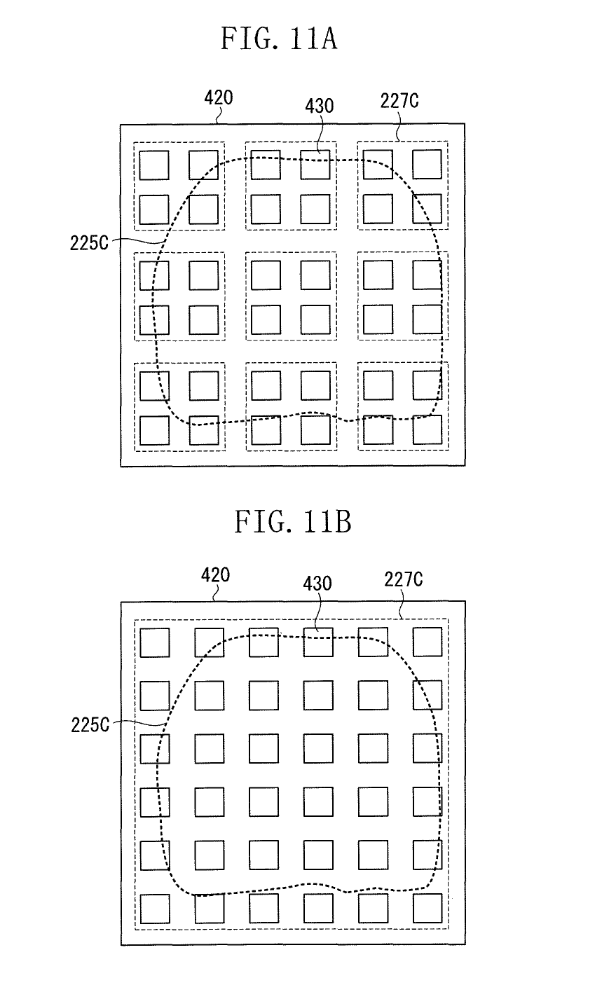

For example, as shown in FIG. 11A, in order to uniformly illuminate a region occupied by four image sensors, the region may be illuminated by one optical rod. As shown in FIG. 11B, in order to uniformly illuminate a region occupied by the all the image sensors, the region may be illuminated by one optical rod. In these cases, the end surface of one optical rod corresponds to four image sensors in FIG. 11A. In FIG. 11B, the end surface of one optical rod corresponds to all the image sensors. Therefore, even when the light sources to be used are determined, the image sensors to be used cannot be uniquely determined.

However, even when illumination unnecessary for imaging is partially carried out, an unnecessary portion is not imaged on the image sensor side if the image sensors to be used are determined.

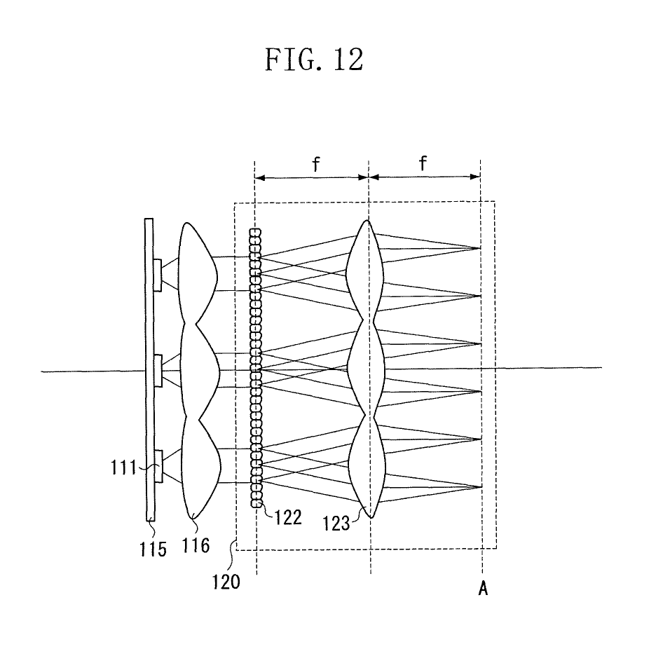

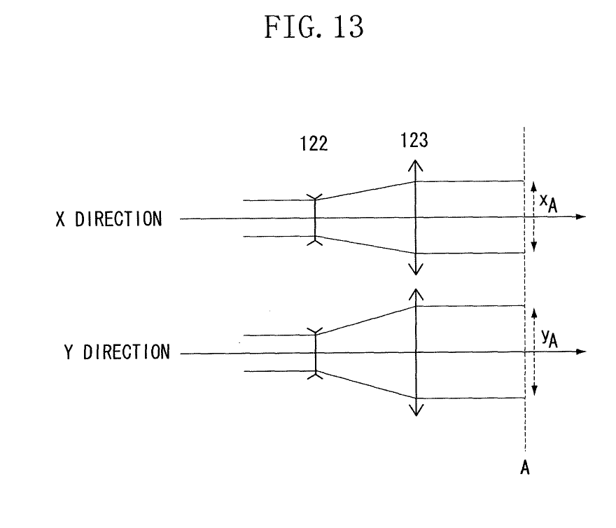

Hereinafter, a fifth exemplary embodiment will be described. The optical rod is used as the integrator used in the illumination optical system in the first to fourth exemplary embodiments. However, a lens array can be also used. The example will be shown in FIG. 12.

Lights radiated from light sources 111 are collimated by a parallelizing lens group 116. The collimated lights are then condensed or diffused by a lens array 122 including minute lenses. An emission surface A corresponding to the emission surface of the optical rod is illuminated by lenses of a parallelizing lens group 123. The emission surface A is configured to have a conjugate relationship with the imaging surface C of the imaging optical system 300. However, the emission surface A is not necessarily disposed at a position completely conjugational to the imaging surface C. The emission surface A may be disposed at a position substantially conjugational to the imaging surface C.

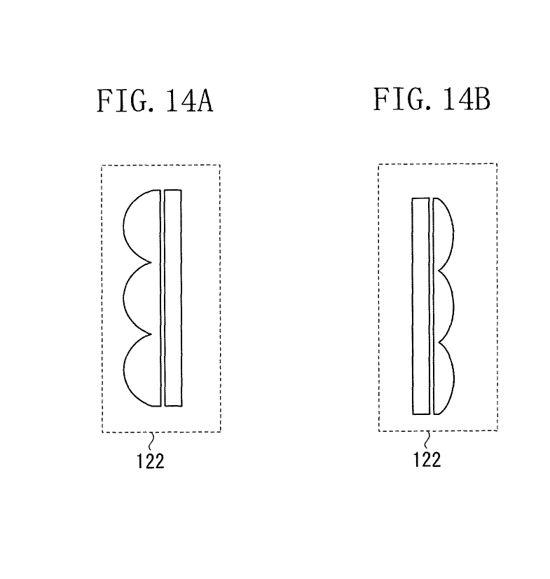

The lens array 122 is formed by connecting a plurality of rectangular lenses having a toroidal surface in which curvature in an X direction is different from curvature in a Y direction. The lenses of the lens array 122 are formed in a rectangle. A size (xA) in the X direction of the emission surface A is made different from a size (yA) in the Y direction by changing the curvatures in two directions, and the light is formed into a shape to match the size of the image sensor. Alternatively, as shown in FIG. 14, the lens array 122 may be used, which is obtained by combining cylindrical lenses which have a cylindrical surface on one side with curvature in only one direction, and a flat surface on the other side.

In this example, when viewed from the X direction, one side has curvature in the X direction, and the other side can be considered to be a flat plate (FIG. 14A). When viewed from the Y direction, one side is a flat plate, and the other side can be considered to have curvature in the Y direction (FIG. 14B).

Returning to FIG. 12, the lens array 122 is separated from the parallelizing lens group 123 by a focal length f of the parallelizing lens group 123. The illumination surface A further separated by the focal length f is illuminated. At this time, luminous fluxes from a plurality of lenses of the lens array 122 are incident on lenses of the parallelizing lens group 123 (shown by luminous rays of FIG. 12), and are superimposed on the emission surface A, to form uniform illumination (Kohler illumination).

In this example, in the emission surface A, a plurality of illumination parts uniformly illuminated by the Kohler illumination corresponding to the light sources are discretely formed. Since an air image can be formed on the emission surface A, a conjugate optical system may be removed, to make the emission surface A coincide with the illuminated surface B. The conjugate optical system may also be disposed as a variable power optical system according to design conditions.

Thereby, the illumination parts are discretely disposed as in the case of using the optical rod, and can be discretely and uniformly formed according to the size and arrangement of the image sensor (FIGS. 5C, 6C).

Therefore, when the light sources and image sensors to be used are determined according to the size of the specimen, the constitution using such a lens array can also reduce electric power consumption and an amount of image data as shown in the first to fourth exemplary embodiments.

While the method for determining the light sources and image sensors to be used is shown in the first to fourth exemplary embodiments, the most efficient method may also be selected according to the conditions in designing the apparatus using the lens array.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-241208 filed Oct. 27, 2010, which is hereby incorporated by reference herein in its entirety.

1. An imaging apparatus comprising:
an illumination optical system comprising a light source and guiding the light from the light source to an illuminated surface including an object;
a plurality of image sensors configured to acquire an image of the illuminated surface formed by an imaging optical system;
a measurement unit configured to measure a size of the object; and
a control unit configured to determine image sensors to be used when acquiring the image of the illuminated surface, among the plurality of image sensors, based on a measurement result of the measurement unit.

2. The imaging apparatus according to claim 1, wherein the control unit determines not to use at least one of image sensors on which an image of the object is not formed, among the plurality of image sensors, based on the measurement result of the measurement unit.

3. The imaging apparatus according to claim 1, wherein the control unit changes an image sensor to be used, among the plurality of image sensors when capturing an image a plurality of times while changing a relative position between the object and the plurality of image sensors in a direction perpendicular to an optical axis of the imaging optical system.

4. The imaging apparatus according to claim 1, wherein the illumination optical system comprises a plurality of light sources, and discretely guides lights from the plurality of light sources to the illuminated surface; and the control unit determines a light source and an image sensor to be used when acquiring the image of the illuminated surface, among the plurality of light sources and the plurality of image sensors.

5. The imaging apparatus according to claim 4, wherein the control unit determines not to use at least one of light sources which do not illuminate the object, among the plurality of light sources based on the measurement result of the measurement unit.

6. The imaging apparatus according to claim 4, wherein the illumination optical system has a plurality of rod integrators; the plurality of light sources independently supply light to the plurality of rod integrators; and emission surfaces of the plurality of rod integrators have a conjugate relationship with an image surface of the imaging optical system.

7. The imaging apparatus according to claim 4, wherein the illumination optical system has a plurality of lens arrays; the plurality of light sources independently supply light to emission surfaces formed by the plurality of lens arrays;
and each of the emission surfaces formed by the plurality of lens arrays has a conjugate relationship with an image surface of the imaging optical system.

8. An imaging apparatus comprising:
an illumination optical system comprising a plurality of light sources and discretely guiding the light from the plurality of light sources to an illuminated surface including an object;
a plurality of image sensors configured to acquire an image of the illuminated surface formed by an imaging optical system;
a measurement unit configured to measure a size of the object; and
a control unit configured to determine a light source to be used when acquiring the image of the illuminated surface, among the plurality of light sources, based on a measurement result of the measurement unit.

9. The imaging apparatus according to claim 8, wherein the plurality of light sources correspond to the plurality of image sensors on a one-on-one basis; and the control unit determines at least one of light sources which are not used when acquiring the image of the illuminated surface, among the plurality of light sources, and determines not to use an image sensor corresponding to the determined light source.

10. The imaging apparatus according to claim 8, wherein the plurality of light sources correspond to the plurality of image sensors on a one-on-one basis; and the control unit determines at least one of image sensors which are not used when acquiring the image of the illuminated surface, among the plurality of image sensors, and determines not to use a light source corresponding to the determined image sensor.

11. The imaging apparatus according to claim 8, wherein the control unit changes a light source to be used, among the plurality of light sources when capturing an image a plurality of times while changing a relative position between the object and the plurality of image sensors in a direction perpendicular to an optical axis of the imaging optical system.

12. An imaging apparatus comprising:
an illumination optical system comprising a plurality of light sources and discretely guiding the light from the plurality of light sources to an illuminated surface including an object;
an image sensor configured to acquire an image of the illuminated surface formed by an imaging optical system;
a measurement unit configured to measure a size of the object; and
a control unit configured to determine not to use at least one of light sources which do not illuminate the object, among the plurality of light sources when acquiring an image of the illuminated surface, based on a measurement result of the measurement unit.
